(19) United States
(12) Patent Application Publication
(10) Pub. No.: US 2015/0116640 A1
(43) Pub. Date: Apr. 30, 2015

(54) LIQUID CRYSTAL COMPONENT, METHOD FOR FABRICATING THE SAME, AND LIQUID CRYSTAL DISPLAY HAVING THE SAME

(71) Applicant: SHENZHEN CHINA STAR OPTOELECTRONICS TECHNOLOGY CO., LTD., Shenzhen,Guangdong (CN)

(72) Inventor: Yuan Xiong, Shenzhen (CN)

(73) Assignee: Shenzhen China Star Optoelectronics Technology Co., Ltd., Shenzhen (CN)

(21) Appl. No.: 14/130,497

(22) PCT Filed: Nov. 13, 2013
(86) PCT No.: PCT/CN2013/087059

§ 371 Date: Jan. 2, 2014

(30) Foreign Application Priority Data
Oct. 30, 2013 (CN) 201310529544.2

(51) Int. Cl. G02F 1/1335

(52) U.S. Cl. CPC G02F 1/133514
USPC 349/106; 438/30

(57) ABSTRACT

The present disclosure provides a liquid crystal component, a method for fabricating the same, and a liquid crystal display having the same. The liquid crystal component includes a COA structure including a TFT and a multilayer color film configured on the TFT, a common electrode located above the COA structure, a capacitor electrode configured between the common electrode and the COA structure, and an insulating layer configured between the common electrode and the capacitor electrode. The capacitor electrode includes a lateral section located between an upper portion of the multilayer color film and the common electrode and an extending section extending from one end of the lateral section and covering a side portion of the multilayer color film.

### BACKGROUND

1. Technical Field

The present disclosure relates to technologies of liquid displays, and more particularly, to a liquid crystal component, a method for fabricating the liquid crystal component, and a liquid crystal display having the same.

2. Description of Related Art

A liquid crystal display having an active matrix array includes a number of pixel areas formed by intersecting a number of gate lines with a number of source lines and a number of TFTs (thin film transistors) configured at the intersections of the gate lines and the source lines. A COF (Color Filter On Array) structure is formed by coating a three-layer RGB color film on the TFTs. In this type of liquid crystal display, each pixel includes a pixel electrode and the TFT is configured for controlling the switching of the on and off of the pixel electrode.

When an image signal is loaded to the TFT, the pixel area is activated and the image signal is applied to the pixel electrode. In order to obtain a display effect of high quality, a voltage applied to the pixel electrode should be maintained unchanged until a next same signal is received. However, charges on the pixel electrode for maintaining the voltage leak quickly, which causes the voltage applied to pixel electrode to decrease too early and further reduces the display effect of the liquid crystal display. Thus, a storage capacitor is often provided to each pixel for maintaining the voltage on the pixel electrode unchanged in a predetermined time.

At present, the method for overcoming the above problem is given in detail as followings. The storage capacitor is configured on the pixel area of the liquid crystal display. In order to further increase a pixel aperture ratio, the storage capacitor includes a first capacitor electrode, a dielectric layer, and a second capacitor electrode, with at least one of the first storage capacitor and the second storage capacitor defining a hole. In this way, since the storage capacitor is configured on the pixel area, the dielectric layer affects the light transmission of the liquid crystal display, thereby reducing the pixel aperture ratio and the display effect of the liquid crystal display.

### SUMMARY

The main object of the present disclosure is to provide a liquid crystal component, a method for fabricating the same and a liquid crystal display having the same for increasing a pixel aperture ratio of the liquid crystal display and further for improving a display effect of the liquid crystal display.

The liquid crystal component provided in the present disclosure includes:
a COA structure including a TFT and a multilayer color film configured on the TFT;
a common electrode located above the COA structure;
a capacitor electrode configured between the common electrode and the COA structure, including a lateral section located between an upper portion of the multilayer color film and the common electrode and an extending section extending from one end of the lateral section and covering a side portion of the multilayer color film; and
an insulating layer configured between the common electrode and the capacitor electrode.

Preferably, the multilayer color film includes a first color film, a second color film, and a third color film overlaying on the TFT in sequence; and the COA structure further includes a pixel area arranged in parallel with the TFT; the extending section includes an inclined section and a protruding section, the inclined section corresponds to the third color film, the second color film, and the first color film, and the protruding section extends from the inclined section and covers a surface of the pixel area.

Preferably, the insulating layer is made of SiNx and the capacitor electrode is made of transparent conductive material.

The method for fabricating a liquid crystal component with a COA structure which includes a TFT and a multilayer color film configured on the TFT, including:
coating conductive material on a substrate with the COA structure formed thereon;
coating a photoresist on the conductive material and exposing the substrate after the photoresist is coated thereon;
developing the exposed substrate and etching the developed substrate;
stripping the photoresist from the etched substrate and thus a capacitor electrode on the multilayer color film is formed wherein the capacitor electrode includes a lateral section located between an upper portion of the multilayer color film and the common electrode and an extending portion extending from one end of the lateral section and covering a side portion of the multilayer color film.

Preferably, the multilayer color film includes a first color film, a second color film, and a third color film overlaying on the TFT in sequence; and the COA structure further includes a pixel area arranged in parallel with the TFT; the extending section includes an inclined section and a protruding section, the inclined section corresponds to the third color film, the second color film, and the first color film, and the protruding section extends from the inclined section and covers a surface of the pixel area.

Preferably, the insulating layer is made of SiNx and the capacitor electrode is made of transparent conductive material.

The liquid crystal display provided in the present disclosure includes a liquid crystal component and a backlight module with light therefrom emitting out after passing through the liquid crystal component; the liquid crystal component including:
a common electrode;
a COA structure including a TFT and a multilayer color film configured on the TFT;
a capacitor electrode configured between the common electrode and the COA structure, the capacitor electrode including a lateral section located between an upper portion of the multilayer color film and the common electrode and an extending portion extending from one end of the lateral section and covering a side portion of the multilayer color film; and
an insulating layer configured between the common electrode and the capacitor electrode.

Preferably, the color film layer includes a first color film, a second color film, and a third color film sequentially overlaying on the TFT; and the COA structure further includes a pixel area arranged in parallel with the TFT; the extending section includes an inclined section and a protruding section, the inclined section corresponds to the third color film, the second color film, and the first color film, and the protruding section extends from the inclined section and covers a surface of the pixel area.

Preferably, the insulating layer is made of SiNx and the capacitor electrode is made of transparent conductive material.

Compared to the conventional liquid crystal display, the lateral section of the capacitor electrode and the common electrode forms the storage capacitor of the liquid crystal display. In this way, the problem that the light transmittance of the liquid crystal display is reduced by configuring the storage capacitor in the pixel area can be solved effectively to increase the pixel aperture ratio of the liquid crystal display and further to improve the display effect of the liquid crystal display.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view illustrating a liquid crystal component in accordance with an embodiment of the present disclosure; and

FIG. 2 is a flow chart of a method for fabricating the liquid crystal component in accordance with an embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

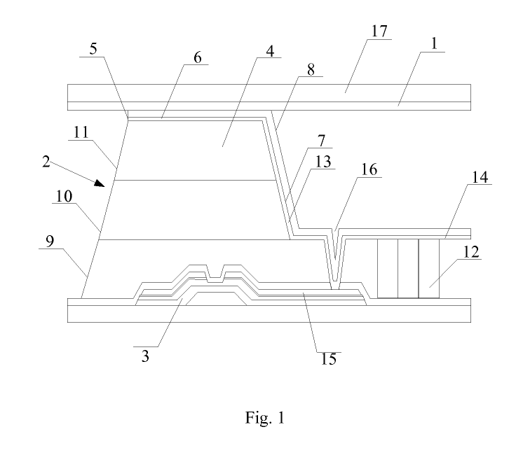

The present disclosure provides a liquid crystal component. FIG. 1 is a schematic view illustrating the liquid crystal component which is given in more detail as follows.

Referring to FIG. 1, the liquid crystal component includes a common electrode 1 and a COA structure 2. The common electrode 1 is located above the COA structure 2. The COA structure 2 includes a TFT 3 and a multilayer color film 4 configured on the TFT 3. The common electrode 1 corresponds to an upper portion of the multilayer color film 4. A capacitor electrode 5 is configured between the common electrode 1 and the COA structure 2. The capacitor electrode 5 includes a lateral section 6 located between the upper portion of the multilayer color film 4 and the common electrode 1, and an extending section 7 extending from one end of the lateral section 6 and covering a side portion of the multilayer color film 4. An insulating layer 8 is configured between the common electrode 1 and the capacitor electrode 5. In an embodiment of the present disclosure, the insulating layer 8 is disposed on the capacitor electrode 5. Optionally, in other embodiments, the insulating layer 8 may be configured on the common electrode 1.

Furthermore, the multilayer color film 4 includes a first color film 9, a second color film 10, and a third color film 11 sequentially overlaying on the TFT 3. The COA structure 2 further includes a pixel area 12 arranged in parallel with the TFT 3. The extending section 7 includes an inclined section 13 corresponding to the third color film 11 and the second color film 10 and a protruding section 14 extending from the inclined section 13 and covering a surface of the pixel area 12.

The lateral section 6 of the capacitor electrode 5 and the common electrode 1 forms a storage capacitor of a liquid crystal display having the liquid crystal component. In this way, the problem that the light transmittance of the liquid crystal display is reduced by configuring the storage capacitor in the pixel area can be effectively solved to increase a pixel aperture ratio of the liquid crystal display and further to improve a display effect of the liquid crystal display.

Furthermore, the TFT 3 includes a conductive electrode 15 configured on an upper portion of the TFT 3. A through hole 16 is defined above the conductive electrode 15 and the conductive electrode 15 contacts with the protruding section 14 of the capacitor electrode 5 through the through hole 16, allowing the TFT 3 to transmit a controlling signal to the protruding section 14 of the capacitor electrode 5 to control rotations of liquid crystal molecules. By defining the through hole 16 above the conductive electrode 15, the controlling signal from the TFT 3 can be transmitted to the protruding section 14 to control the rotations of the liquid crystal molecules.

Furthermore, the common electrode 1 is coated on another glass substrate 17 and liquid crystals (not shown) are ejected into a space defined between the common electrode 1 and the protruding section 14 of the capacitor electrode 5. Light from a backlight source (not shown) enters into the liquid crystals between the common electrode 1 and the protruding section 14 of the capacitor electrode 5 after running through the pixel electrode 12 and thereafter emits out from the liquid crystals through the common electrode 1.

Furthermore, in order to provide good insulation between the capacitor electrode 5 and the common electrode 1, the insulating layer 8 is preferably made of SiNx. In other embodiments, the insulating layer 8 can be made of other suitable material.

Furthermore, in order to reduce the influence on the light transmittance of the liquid crystal component, the capacitor electrode 5 is preferably made of transparent conductive material such as indium tin oxide (ITO) or indium zinc oxide (IZO). In other embodiments, the capacitor electrode 5 can be made of other suitable conductive material.

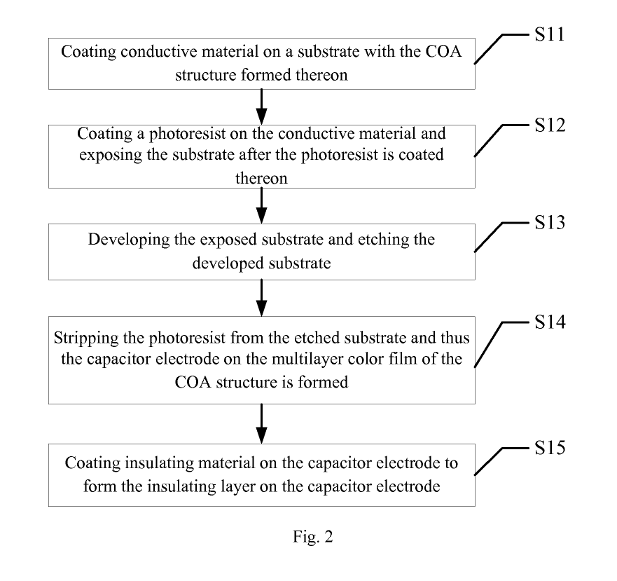

The present disclosure further provides a method for fabricating the above liquid crystal component. Referring to FIG. 2, which is a flow chart of the method for fabricating the liquid crystal component, the method is given in detail as follows.

Step S11, coating conductive material on a substrate with the COA structure formed thereon.

Step S12, coating a photoresist on the conductive material and exposing the substrate after the photoresist is coated thereon.

Step S13, developing the exposed substrate and etching the developed substrate.

Step S14, stripping the photoresist from the etched substrate and thus the capacitor electrode on the multilayer color film of the COA structure is formed wherein the capacitor electrode includes the lateral section located between the multilayer color film and the common electrode and the extending section extending from one end of the lateral section and covering the side portion of the multilayer color film.

Step S15, coating insulating material on the capacitor electrode to form the insulating layer on the capacitor electrode.

Specifically, forming the capacitor electrode on the glass substrate with the COA structure formed thereon, that is, forming the capacitor electrode on one side of the glass substrate with the COA structure formed thereon, and forming the insulating layer on the capacitor electrode includes: coating the conductive material and the photoresist in sequence on the glass substrate with the COA structure formed thereon; irradiating a special area of the substrate after the conductive material and the photoresist are coated thereon in sequence with ultraviolet light via a special photomask, that is, exposing the substrate after the conductive material and the photoresist are coated thereon in sequence; and developing the exposed substrate. The special photomask is opened at special positions according to the property of the photoresist. If the photoresist is a negative photoresist, the photoresist which corresponds to the opened area of the photomask and is exposed to the ultraviolet light is not developed. If the photoresist is a positive photoresist, the photoresist which corresponds to the opened area and is exposed to the ultraviolet light is developed.

In an embodiment of the present disclosure, if the photoresist is a negative photoresist, the photomask is opened at positions corresponding to the lateral section and the extending section. If the photoresist is positive photoresist, the photomask is opened at positions which do not correspond to the lateral section and the extending section. The capacitor electrode formed according to this way includes the lateral section located between an upper portion of the multilayer color film and the common electrode and the extending section extending from one end of the lateral section to cover the side portion of the multilayer color film. The step of forming the insulating layer on the capacitor electrode includes: coating the insulating material on the substrate with the capacitor electrode formed thereon, and curing the coated insulating material to form the insulating layer on the capacitor electrode. The insulating material can be cured by baking or ultraviolet light or any other suitable method. In other embodiments, the insulating layer can be formed on the common electrode and then the step of forming the insulating layer on the common electrode includes: coating the insulating material on the glass substrate with the common electrode formed thereon and curing the coated insulating material to form the insulating layer on the common electrode.

Furthermore, the TFT of the liquid crystal component includes a conductive electrode formed on an upper portion of the TFT. A through hole is defined above the conductive electrode and the protruding section of the extending section of the capacitor electrode contacts with the conductive electrode through the through hole, allowing the TFT 3 to transmit a controlling signal to the protruding section 14 of the capacitor electrode 5 to control rotations of liquid crystal molecules. By defining the through hole 16 above the conductive electrode 15, the controlling signal from the TFT 3 can be transmitted to the protruding section 14 to control the rotations of the liquid crystal molecules.

Furthermore, the common electrode is coated on another glass substrate which is opposite to the glass substrate with the COA structure formed thereon and liquid crystals (not shown) are ejected into a space defined between the common electrode 1 and the protruding section of the capacitor electrode. Light from a backlight source (not shown) enters into the liquid crystals between the common electrode and the protruding section of the capacitor electrode after passing through the pixel electrode and thereafter emits out from the liquid crystals through the common electrode.

Furthermore, in order to reduce the influence on the light transmittance of the liquid crystal component, the capacitor electrode is preferably made of transparent conductive material such as indium tin oxide (ITO) or indium zinc oxide (IZO). In other embodiments, the capacitor electrode can be made of other suitable conductive material.

The lateral section 6 of the capacitor electrode 5 and the common electrode 1 forms a storage capacitor of the liquid crystal display. In this way, the problem that the light transmittance of the liquid crystal display is reduced by configuring the storage capacitor in the pixel area can be effectively solved to increase the pixel aperture ratio of the liquid crystal display and further to improve the display effect of the liquid crystal display.

The present disclosure further provides a liquid crystal display, including a backlight module and a liquid crystal component. The liquid crystal component includes a common electrode and a COA structure. The common electrode is located above the COA structure. The COA structure includes a TFT and a multilayer color film configured on the TFT. The common electrode corresponds to an upper portion of the multilayer color film. A capacitor electrode is configured between the common electrode and the COA structure. The capacitor electrode includes a lateral section configured between the upper portion of the multilayer color film and the common electrode and an extending portion extending from one end of the lateral section and covering a side portion of the multilayer color film. An insulating layer is configured between the common electrode and the capacitor electrode. Light from the backlight module emits out after passing through the liquid crystal component.

The liquid crystal component of the liquid crystal display is the same as the liquid crystal component described above, and the structure of the liquid crystal component and the method for fabricating the liquid crystal component can be referred to those of the liquid crystal component described above, which is not given in detail herein anymore. Compared to the conventional liquid crystal display, the problem that the light transmittance of the liquid crystal display is reduced by configuring the storage capacitor in the pixel area can be effectively solved to increase the pixel aperture ratio of the liquid crystal display and further to improve the display effect of the liquid crystal display.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal component, comprising:
a COA structure comprising a TFT and a multilayer color film configured on the TFT;
a common electrode located above the COA structure;
a capacitor electrode configured between the common electrode and the COA structure, comprising a lateral section located between an upper portion of the multilayer color film and the common electrode and an extending section extending from one end of the lateral section and covering a side portion of the multilayer color film; and
an insulating layer configured between the common electrode and the capacitor electrode.

2. The liquid crystal component of claim 1, wherein the insulating layer is made of SiNx and the capacitor electrode is made of transparent conductive material.

3. The liquid crystal component of claim 1, wherein the multilayer color film comprises a first color film, a second color film, and a third color film overlaying on the TFT in sequence; and the COA structure further comprises a pixel area arranged in parallel with the TFT.

4. The liquid crystal component of claim 3, wherein the insulating layer is made of SiNx and the capacitor electrode is made of transparent conductive material.

5. The liquid crystal component of claim 3, wherein the extending section comprises an inclined section and a protruding section, the inclined section corresponds to the third color film, the second color film, and the first color film, and the protruding section extends from the inclined section and covers a surface of the pixel area.

6. The liquid crystal component of claim 5, wherein the insulating layer is made of SiNx and the capacitor electrode is made of transparent conductive material.

7. A method for fabricating a liquid crystal component with a COA structure which comprises a TFT and a multilayer color film configured on the TFT, comprising:
coating conductive material on a substrate with the COA structure formed thereon;
coating a photoresist on the conductive material and exposing the substrate after the photoresist is coated thereon;
developing the exposed substrate and etching the developed substrate;
stripping the photoresist from the etched substrate and thus a capacitor electrode on the multilayer color film is formed wherein the capacitor electrode comprises a lateral section located between an upper portion of the multilayer color film and the common electrode and an extending portion extending from one end of the lateral section and covering a side portion of the multilayer color film.

8. The method of claim 7, wherein the insulating layer is made of SiNx and the capacitor electrode is made of transparent conductive material.

9. The method of claim 7, wherein the multilayer color film comprises a first color film, a second color film, and a third color film overlaying on the TFT in sequence; and the COA structure further comprises a pixel area arranged in parallel with the TFT.

10. The method of claim 9, wherein the insulating layer is made of SiNx and the capacitor electrode is made of transparent conductive material.

11. The method of claim 9, wherein the extending section comprises an inclined section and a protruding section, the inclined section corresponds to the third color film, the second color film, and the first color film, and the protruding section extends from the inclined section and covers a surface of the pixel area.

12. The method of claim 11, wherein the insulating layer is made of SiNx and the capacitor electrode is made of transparent conductive material.

13. A liquid crystal display, comprising:
a liquid crystal component comprising:
a common electrode;
a COA structure comprising a TFT and a multilayer color film configured on the TFT;
a capacitor electrode configured between the common electrode and the COA structure, the capacitor electrode comprising a lateral section located between an upper portion of the multilayer color film and the common electrode and an extending portion extending from one end of the lateral section and covering a side portion of the multilayer color film; and
an insulating layer configured between the common electrode and the capacitor electrode; and
a backlight module with light therefrom emitting out after passing through the liquid crystal component.

14. The liquid crystal display of claim 13, wherein the insulating layer is made of SiNx and the capacitor electrode is made of transparent conductive material.

15. The liquid crystal display of claim 13, wherein the color film layer comprises a first color film, a second color film, and a third color film overlaying on the TFT in sequence; and the COA structure further comprises a pixel area arranged in parallel with the TFT.

16. The liquid crystal display of claim 15, wherein the insulating layer is made of SiNx and the capacitor electrode is made of transparent conductive material.

17. The liquid crystal display of claim 15, wherein the extending section comprises an inclined section and a protruding section, the inclined section corresponds to the third color film, the second color film, and the first color film, and the protruding section extends from the inclined section and covers a surface of the pixel area.

18. The liquid crystal display of claim 17, wherein the insulating layer is made of SiNx and the capacitor electrode is made of transparent conductive material.
